(19) United States
(12) Patent Application Publication
(10) Pub. No.: US 2014/0217818 A1
(43) Pub. Date: Aug. 7, 2014

(54) METHOD FOR OPERATING SEVERAL LOADS IN ALTERNATING CURRENT NETWORKS WITH LEADING EDGE OR TRAILING EDGE PHASE CUTTING

(71) Applicants: Wolfgang Becker, Schaafheim (DE); Edgar Rueth, Kahl am Main (DE); Benedikt Klein, Feldkahl (DE)

(72) Inventors: Wolfgang Becker, Schaafheim (DE); Edgar Rueth, Kahl am Main (DE); Benedikt Klein, Feldkahl (DE)

(73) Assignee: SINGULUS TECHNOLOGIES AG, Kahl am Main (DE)

(21) Appl. No.: 14/131,963

(22) PCT Filed: Jul. 12, 2012
(86) PCT No.: PCT/EP2012/063672

§ 371 Date: Mar. 27, 2014

(30) Foreign Application Priority Data
Jul. 13, 2011 (DE) 10 2011 079 053.5
Dec. 1, 2011 (DE) 10 2011 119 932.6

(51) Int. Cl. H02J 3/00

(52) U.S. Cl. CPC H02J 3/00
USPC 307/11

(57) ABSTRACT

A method for operating a first and a second electrical load or consumer in an alternating current network. The method can be operated in an optional first operating mode, in which the positive and negative half waves for each load are controlled with a first leading edge phase angle. In addition, a second operating mode is provided, in which a first part of the positive and negative half waves for the first load and a second part of the positive and negative half waves for the second load are controlled with respective second leading edge phase angles. Furthermore, a device for performing the method, having first and second leading edge phase-angle control for the first and second loads.

### BACKGROUND

1. Field of the Disclosure

The present disclosure relates to a device and a method for operating several loads or consumers in alternating current networks with leading edge or trailing edge phase cutting or switching.

In particular, devices for producing thin film solar cells, high-power heating processes are required, wherein for optimizing the processes also control ranges with relatively low heating power should be allowed. For this purpose, i.a. leading edge phase-angle control means are used in order to heat substrates, e.g., made of glass, as homogeneously as possible.

2. Discussion of the Background Art

Leading edge phase-angle control means are disadvantageous in view of the non-sinusoidal shape of the current, because the current flows only in a part of the half wave. The lower the required current, the larger the leading edge phase angle (e.g. 90° to 180° corresponding to 50% to 0%) and the greater the deviation of the current's curve shape from the sine shape. This leads to reactions in the form of harmonics on the supplying network. These reactions should be restricted, e.g., in accordance with specific standards (e.g. EN61000-3-2, EN61000-3-12, EN61000-2-2, EN61000-2-4 and EN50160), because the losses caused by harmonic currents in the supply networks can be significant.

For reducing harmonics, DE 197 05 907 A1 suggests to vary the firing angle around the predetermined desired firing angle in order to provide a power control of electrical consumers connected to an AC supply network by a leading edge phase-angle circuit.

EP 1 529 335 B1 provides an apparatus in which a second switching element is earlier switched into the conducting state so that current is flowing which, after firing of the actual first switching element, is taken over by the first switching element. This leads to a relatively smooth increase in the current as a whole, so that the harmonics are thus reduced or partly extinguished.

DE 10 2007 059 789 B3 suggests to select the firing angle per half wave of the alternating current in a periodic sequence in such a manner that the power varies in a sinusoidal manner, without the equilibrium of the power being cancelled out on average between positive and negative half waves. It is thus possible to design the generated harmonics such that they can extinguish each other on average.

### SUMMARY

It is the object of the present disclosure to provide a device and a method for reducing harmonics during load operation with leading edge phase switching over a relatively large power control range and also in case of a relatively low load, in order to achieve, e.g., a particularly uniform heating profile for glass substrates. For this purpose, especially economically suitable measures for meeting the limit values should be found in the standards described above. This object is achieved by the features of the claims.

The disclosure starts out from the concept of a normal leading edge phase-angle control of two or more consumers, wherein each consumer uses both leading-edge phase-angle controlled half waves (first operating mode). As discussed above, in case of a low load of the consumers, the disturbances and reactions on the network are great, all the more since the switching-on phases for the two consumers overlap each other. According to the disclosure, a second operating mode is provided for this purpose, in which a specific number of subsequent half waves are driven only for the first consumer and the specific number of the then following partial waves are driven only for the second consumer etc., in each case with a second leading edge phase angle.

The disclosure thus generally relates to a method with an optional first operating mode, in which the positive and negative half waves for each consumer are driven with a first leading edge phase angle or a first trailing edge phase angle, and a second operating mode, in which a first part of the positive and negative half waves is controlled (only) for the first consumer and a second part of the positive and negative half waves (only) for the second consumer, in each case with a second leading edge phase angle or a second trailing edge phase angle.

For example, the first part of the half waves can be the positive half waves and the second part of the half waves the negative half waves.

In accordance with such an embodiment, the disclosure can relate to a method in an AC network in which a first and a second electrical consumer should be operated under a load of 0% to 50%. Here, the negative half waves can be switched off for the first consumer and the positive half waves for the second consumer, and the positive half waves can be switched on for the first consumer and the negative half waves for the second consumer (e.g., with a second leading edge phase angle), i.e. the negative half waves are used only for one consumer and the positive half waves only for the other consumer.

The method according to the disclosure for operating a first and a second electrical consumer in an AC network can provide for a first operating mode, in which the positive and negative half waves are driven for each consumer with a first leading edge phase angle. Moreover, if the first leading edge phase angle is at least 90°, it can be switched to a second operating mode by switching-off the negative half waves for the first consumer and the positive half waves for the second consumer and driving the positive half waves for the first consumer and the negative half waves for the second consumer with a second leading edge phase angle.

For example, if the load is relatively low and the leading edge phase angle lies in this known concept (first leading edge phase angle) in the range of 90° to 180°, i.e. the load of each half wave is in the range of 50% to 0%, a different operating mode can be activated, in which one consumer uses only the positive half waves and the other consumer only the negative half waves.

Also in case of a relatively low power consumption of the consumers, the leading edge phase angle (=second leading edge phase angle) of the two half waves and thus the deviation of the current curve from the sine shape can thus be reduced as compared to the known solution (with the first leading edge phase angle), so that the reactions on the network in the form of harmonics are reduced.

The disclosure can also relate to a method for operating a first and a second electrical consumer in an AC network, wherein the method comprises only the first operating mode described above or only the second operating mode described above.

In accordance with an embodiment, for a number of consumers q≧2, the first part of the positive and negative half waves can be the half waves of the (1+q·(N−1)·Z)-th full waves,

the second part of the positive and negative half waves can be the half waves of the (Z+1+q·(N'1)·Z)-th full waves, and

a q^{th} part of the positive and negative half waves can be the half waves of the ((q−1)·Z+1+q·(N−1)·Z)-th full waves,

wherein N is an integer greater than zero and Z is the number of subsequent full waves for a consumer.

For example, for a first one of exactly two consumers, with one respective switched full wave per consumer, the first, third, fifth, seventh, etc. full waves are driven, wherein the second, fourth, sixth, eighth, etc. full waves are switched for the second consumer. If there are exactly two consumers and two respective full waves, the first and second, fifth and sixth, etc. full waves are driven for the first consumer and for the second consumer the third and fourth, seventh and eighth, etc. full waves.

If there are exactly three consumers and one full wave, for example, for the first consumer the first, fourth, seventh, etc., for the second consumer the second, fifth, eighth, etc., and for the third consumer the third, sixth, ninth, etc. full waves can be driven. If there are exactly three consumers and two respective full waves, for the first consumer the first and second, seventh and eighth, etc. full waves can be driven, for the second consumer the third and forth, ninth and tenth, etc. full waves and for the third consumer the fifth and sixth, eleventh and twelfth full waves.

The disclosure also relates to a device which is suitable for carrying out the general concept of the disclosure described above. In this case, the device comprises in particular a first and a second leading edge phase-angle control means (or more than two leading edge phase-angle control means) for a first and a second (or more than two) consumer(s). The first leading edge phase-angle control means is suitable for driving a first part of the positive and negative half waves for the first consumer, and the second leading edge phase-angle control means is suitable for driving a second part of the positive and negative half waves for the second consumer. The leading edge phase-angle control means are suitable for driving the half waves with a second leading edge phase angle or with a second trailing edge phase angle, for example, if a first leading edge phase angle or a first trailing edge phase angle is provided for the operating mode described above.

For example, the first part of the half waves can be the positive half waves and the second part of the half waves can be the negative half waves.

In accordance with such an embodiment, the disclosure can also relate to a device for operating electrical consumers in an AC network with a first leading edge phase angle of at least 90°, in particular a device for carrying out one of the methods defined above and/or below. The device can comprise a first and a second leading edge phase-angle control means for a first and a second (electrical) consumer, wherein the first leading edge phase-angle control means is suitable for switching off the negative half waves for the first consumer, and wherein the second leading edge phase-angle control means is suitable for switching off the positive half waves for the second consumer. The leading edge phase-angle control means are moreover preferably suitable for driving the positive half waves for the first consumer and the negative half waves for the second consumer with a second leading edge phase angle.

In accordance with an embodiment, the device can be suitable for driving for a number q≧2 of consumers, as the first part of the positive and negative half waves, the half waves of the (1+q·(N−1)·Z)-th full waves,

as the second part of the positive and negative half waves, the half waves of the (Z+1+q·(N−1)·Z)-th full waves, and

as a q^{th} part of the positive and negative half waves, the half waves of the ((q−1)·Z+1+q·(N−1)·Z)-th full waves,

wherein N is an integer greater than zero and Z is the number of subsequent full waves for a consumer.

In accordance with an embodiment, the electrical consumers comprise lamps such as IR radiators for heating processes for producing thin film solar cells.

A leading edge phase-angle control means can control the current flow in an AC network in such a manner that after the zero crossing of the alternating current, the current does not flow to the consumer until the control means receives a firing pulse. In this phase of the AC signal, to which a specific leading edge phase angle can be assigned, the connected consumer is supplied with current until the next zero crossing. The duration from the zero crossing until the firing pulse is referred to as leading edge phase switching, wherein the power decreases as the duration increases (smaller leading edge phase switching, e.g., between 0% and 50%, and larger leading edge phase angle, e.g., 180° and)90°. In other words, if a leading edge phase switching is 100%, the firing pulse is not delayed (leading edge phase angle of 0°, while a leading edge phase switching of 0% corresponds to the maximum delay until zero crossing (leading edge phase angle of 180°.

In accordance with an embodiment of the disclosure, the negative and positive (sine) half waves of the network current are switched off for the first and the second consumer, and the latter are driven with a second leading edge phase angle, which is equal for the consumers themselves but is different from that used in case the half waves are not switched off. It is thus possible to maintain the power for the two consumers although specific half waves are switched off as compared to the case in which the half waves are not switched off. Moreover, by switching off specific half waves, a structural overlap of the load by the first and the second consumer can be prevented.

In accordance with an embodiment of the method and the device, the second leading edge phase angle (in case there are only positive or only negative half waves for a consumer) is smaller than the first leading edge phase angle (when using both the positive and the negative half waves for each consumer). By switching off specific half waves, the second leading edge phase switching can be shortened relative to the first leading edge phase switching for achieving the same power (as compared to the case in which the half waves are not switched off).

Thus, it is possible to adapt the power with switched-off half waves to the power without switched-off half waves, in particular the switching-off of the half waves can be compensated for in this manner.

In accordance with an embodiment of the method and the device, the first leading edge phase switching is twice the size of the second leading edge phase switching. The larger the leading edge phase switching, the longer the delay until a consumer can be supplied with energy and the lower the power. For compensating for a power loss caused by switching-off the half waves, e.g., the delay until current flow, i.e. the leading edge phase switching, can be reduced to half for driving the non-switched-off half waves.

In accordance with an embodiment, the consumers can be synchronized, preferably by the device described above, such that the controlled positive and negative half waves are not superimposed structurally and/or destructively. It is thus possible to avoid that the load amplitudes for the current network add, not even partly.

In accordance with an embodiment, the method steps described above represent the second operating mode, in which one consumer uses only the positive or only the negative half waves and the other consumer uses only the other (either only the negative or only the positive) half waves. Furthermore, the method can switch from the second into the first operating mode (in particular automatically). In the first operating mode, each consumer uses both the positive and the negative half waves. Switching from the second into the first operating mode is possible at any time, but it becomes necessary if a further increase in the load range is required in the second operating mode while reducing the leading edge phase angle to 0°.

Thus, the electrical consumers can be operated in the first operating mode in such a manner that positive and negative half waves are driven for both the first and the second consumer. In this second operating mode there is thus no switching-off of specific half waves, so that the combination of the two operating modes provides for an increased power control range.

Also the above-mentioned device according to the disclosure and its embodiments can accordingly be adapted to carry out this first operating mode. Moreover, means can be provided for switching between the first and the second operating mode and/or vice versa, so that it is switched from the first operating mode, in which both consumers use both half waves and in which it is determined that the leading edge phase angle lies in the range of 180° to 90°, preferably in a range of less than 180° to more than 90°, into a second operating mode, in which one consumer uses only one half wave and the other consumer only the other half wave, and wherein the leading edge phase angle is reduced during switching so that the omission of the half wave for the respective consumer is power-compensated and/or such that it is switched from the second operating mode, in which it is determined that the leading edge phase angle is approximately 0° or equal to 0°, into the first operating mode, and wherein the leading edge phase angle is increased during switching so that the addition of the half wave for the two consumers is power-compensated.

In accordance with the disclosure, also more than two consumers can be used. In this case, the consumers are divided, e.g., into two consumer groups whose network load can be as equal as possible or approximately equal. The two consumer groups can then be operated in the same manner as the two consumers described above in accordance with the disclosure.

The principle of the disclosure can accordingly also be used in connection with trailing edge phase control, wherein the current flows between the zero crossing and the firing pulse.

In the following, the disclosure will be explained in more detail with reference to the drawings in which

### BRIEF DESCRIPTION OF THE DRAWINGS

FIG. 1 shows a schematic illustration of an exemplary circuit,

FIG. 2(a) shows the network load by a first consumer with a first leading edge phase switching of 35%,

FIG. 2(b) shows the network load by a second consumer with a first leading edge phase switching of 35%,

FIG. 2(c) shows the overall network load by the two consumers of FIG. 2(a) and FIG. 2(b),

FIG. 3(a) shows the network load by a first consumer with a leading edge phase switching of 70% with switched-off negative half wave,

FIG. 3(b) shows the network load by a second consumer with a leading edge phase switching of 70% with switched-off positive half wave,

FIG. 3(c) shows the overall network load by the two consumers of FIG. 3(a) and FIG. 3(b),

FIG. 4 shows the overall network load of FIG. 3(c) as compared to the overall network load of FIG. 2(c),

FIG. 5 shows the overall network load by two consumers with a leading edge phase switching of 40% with switched-off negative and positive half waves, respectively, as compared to the overall network load by two consumers with a leading edge phase switching of 20% and without switching-off the respective half waves,

FIG. 6 shows the overall network load by two consumers with a leading edge phase switching of 98% with switched-off negative and positive half waves, respectively, as compared to the overall network load by two consumers with a leading edge phase switching of 49% and without switching-off the respective half waves, and

FIG. 7 shows the ratio of the amplitudes of the harmonics for a leading edge phase switching of 35% according to FIG. 2(c) and for a leading edge phase switching of 70% with switched-off half waves according to FIG. 3(c) from Fourier transformation.

### DETAILED DESCRIPTION OF THE PREFERRED EMBODIMENT

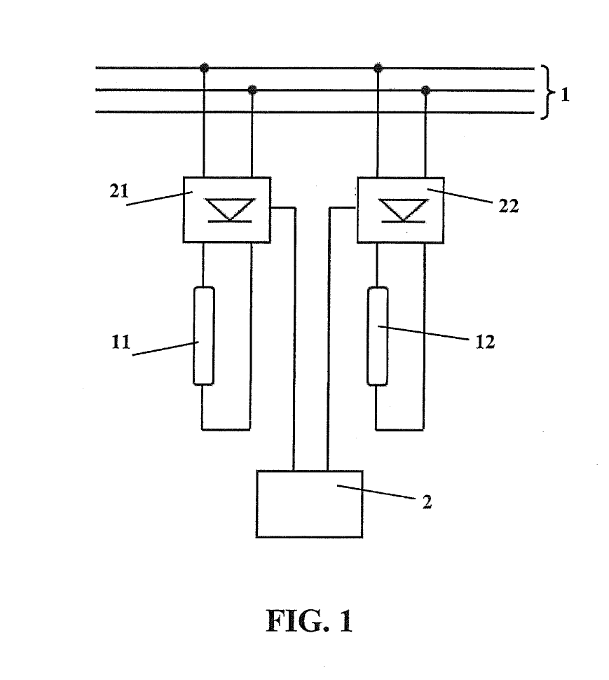

FIG. 1 shows an exemplary circuit for a device with two loads or consumers 11, 12 and two leading edge phase-angle control means (actuators) 21, 22 for controlling the current flow and an AC network 1. After the zero crossing of the AC current, the leading edge phase-angle control means delays the current flow and switches it on (“controlling” or “driving”) in case of a specific leading edge phase angle, so that the current flows until the next zero crossing. The control circuit 2 performs the controlling or driving operation. A (inverse) measure for the duration of the delay of the current flow is the leading edge phase switching, it is large in case of small leading edge phase angles and small in case of large leading edge phase angles. The consumers 11, 12 are connected in parallel and can be driven by the AC network 1. The first consumer 11 is driven by the first leading edge phase-angle control means 21, while the second leading edge phase-angle control means 22 drives the second consumer 12. The leading edge phase-angle control means 21, 22 can switch off the negative and positive half waves of the network phase for the first and second consumers 11, 12, respectively, by using the control circuit 2, and they are preferably configured so that they drive the non-switched-off half waves with the same leading edge phase angle.

For example, during load operation, the consumers 11, 12, e.g. lamps such as IR radiators for heating processes for the production of thin film solar cells, should be driven with a first leading edge phase angle of at least 90°. In this connection it is suggested in accordance with the present disclosure that the device, in particular, e.g., the first leading edge phase-angle control means 21 switches off the negative half waves for the first consumer 11 and controls the positive half waves, which are not switched off, with a different (second) leading edge phase angle, which is preferably smaller than the first leading edge phase angle, in particular half the size of the first leading edge phase angle. For the second consumer 12, the device, e.g., the second leading edge phase-angle control means 22, switches off the positive half waves of the network phase and controls the remaining, non-switched-off negative half waves with the second leading edge phase angle, in particular with the same leading edge phase angle as that described in connection with the first consumer 11.

It can thus be avoided that the network loads by the consumers 11, 12 are superimposed structurally, and harmonics can be reduced and thus reactive power can be accordingly prevented because—with equal power output—the second leading edge phase angle is smaller when switching off the half waves than the first leading edge phase angle when using both half waves for both consumers.

In the following, examples of specific leading edge phase switching operations with switched-off half waves and without switched-off half waves are compared with each other.

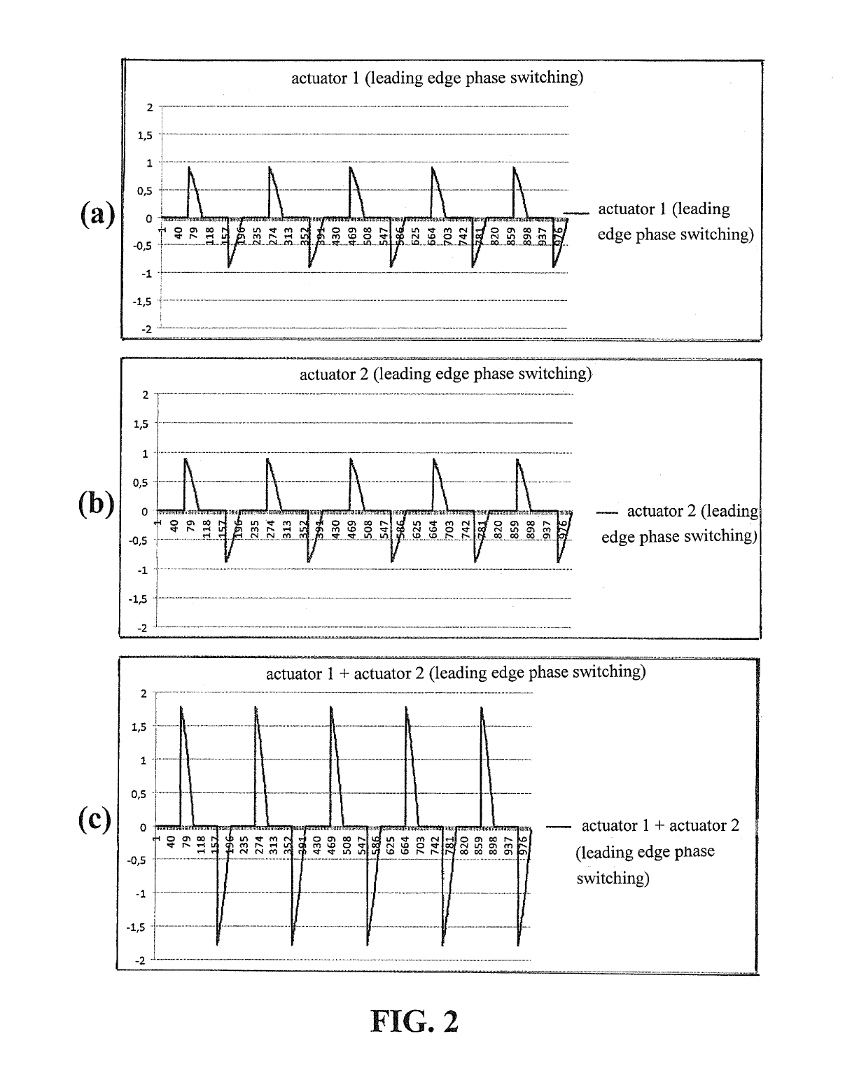

FIG. 2(a) and FIG. 2(b) show the network load by a first and a second consumer with a leading edge phase switching of 35% without switching-off the half waves. FIG. 2(c) shows the overall network load by these two consumers, which results from a superimposition of the curves of FIG. 2(a) and FIG. 2(b). The amplitude of the overall network load is thus doubled in case the curves of the two consumers are superimposed structurally.

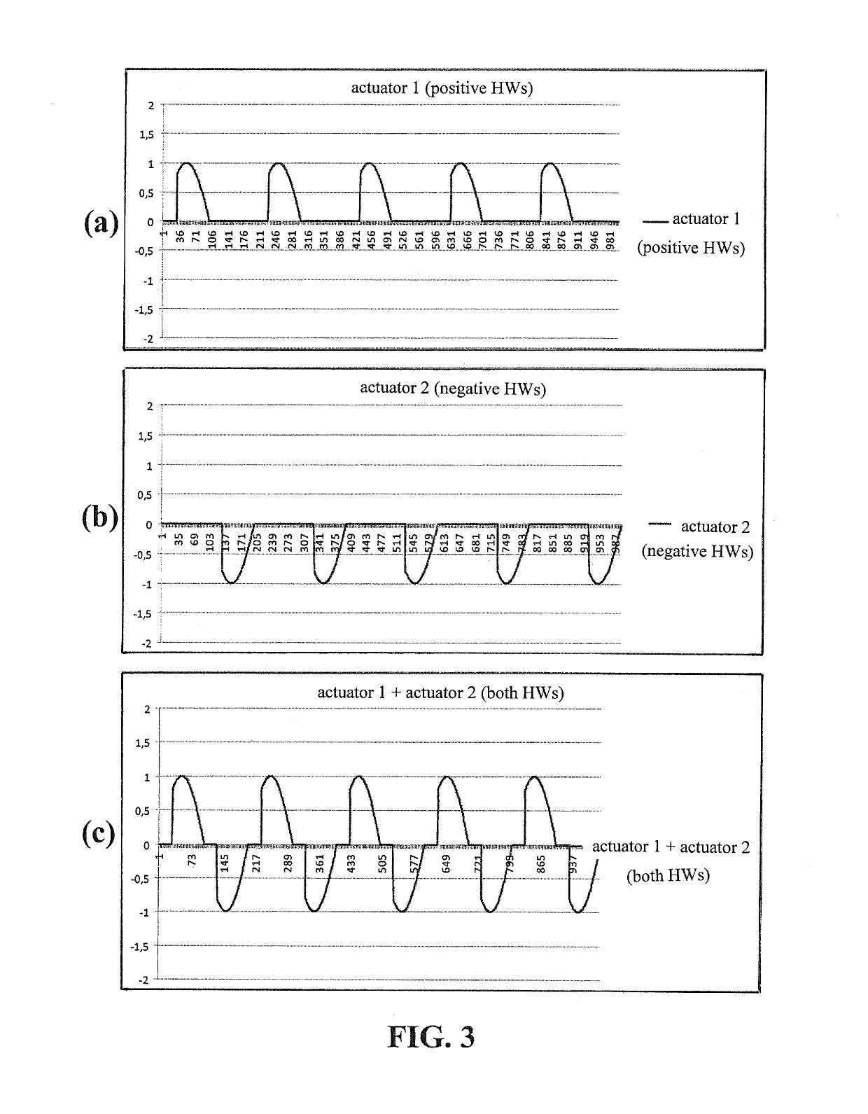

FIG. 3(a) shows the network load by a first consumer with a leading edge phase switching of 70%, wherein the negative half waves have been switched-off. As compared to a leading edge phase angle of 35%, which corresponds to the shape of the curve of FIG. 2(a), double the leading edge phase switching has been controlled for achieving the same power.

Analogously to FIG. 3(a), FIG. 3(b) shows the network load by a second consumer with a leading edge phase switching of 70%. In contrast to FIG. 3(a), the positive half waves (HWs) have been switched-off, so that only the negative half waves (HWs) with the same double percentage as in FIG. 3(a), i.e. 70%, have been controlled.

When looking at the overall load of the two curves of FIG. 3(a) and FIG. 3(b), it is evident that the network loads of the two consumers are not superimposed structurally, see FIG. 3(c).

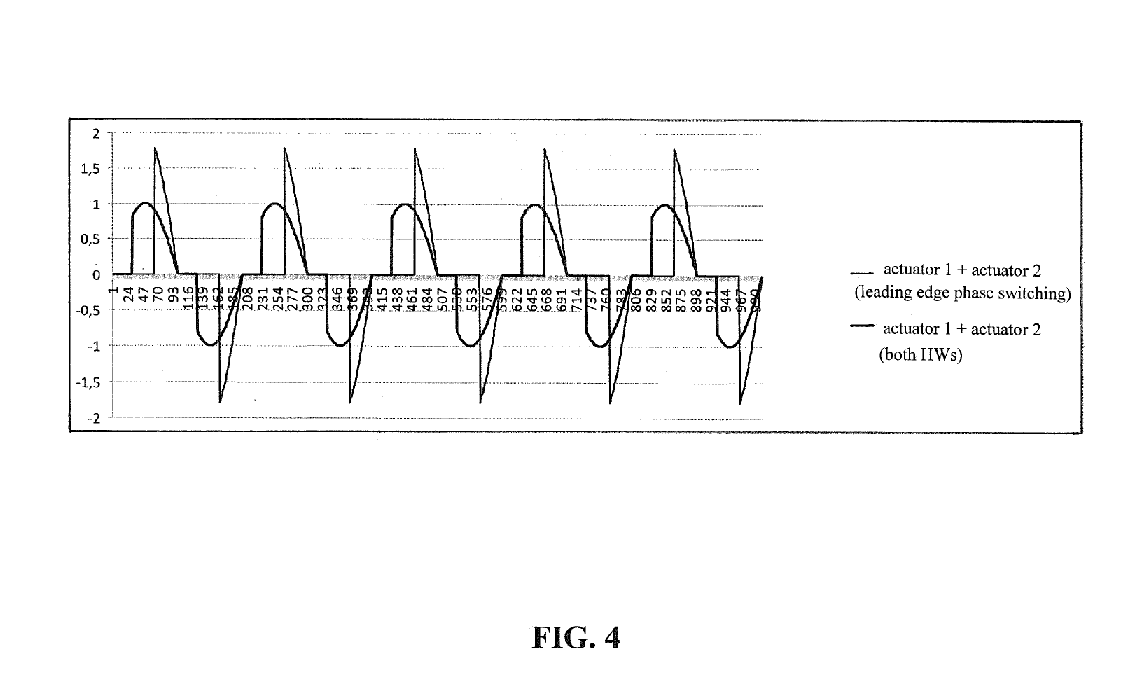

A comparison of the overall network load of FIG. 2(c) (without switching-off the half waves) and the overall network load of FIG. 3(c) (with switching-off the half waves and double leading edge phase switching) shows in FIG. 4 that the network load amplitudes and the deviation of the current's curve shape from the sine shape are—with the same power—clearly greater in the case in which the half waves are not switched off than in the case in which the corresponding half waves are switched off.

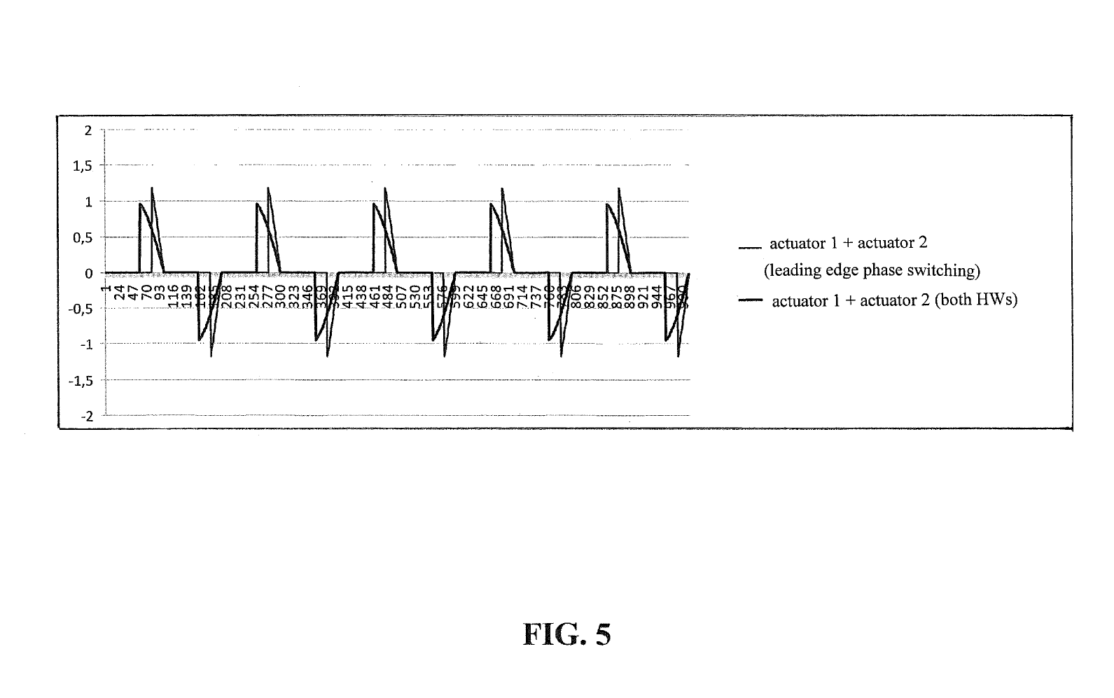

FIG. 5 shows a further example of the reduction in the amplitudes of the overall network load by two consumers. The curve “actuator 1+actuator 2” shows the load by two consumers with a leading edge phase switching of 20%, wherein the curve “actuators 1+2 (both HWs)” shows the load by two consumers with switched-off negative and positive half waves and a leading edge phase switching of 40%. Here, too, it is clear that the amplitude and the deviation of the current curve from the sine shape are smaller with switched-off half waves and greater leading edge phase switching (and thus the same power as in the case in which the half waves are not switched-off) than without switching-off.

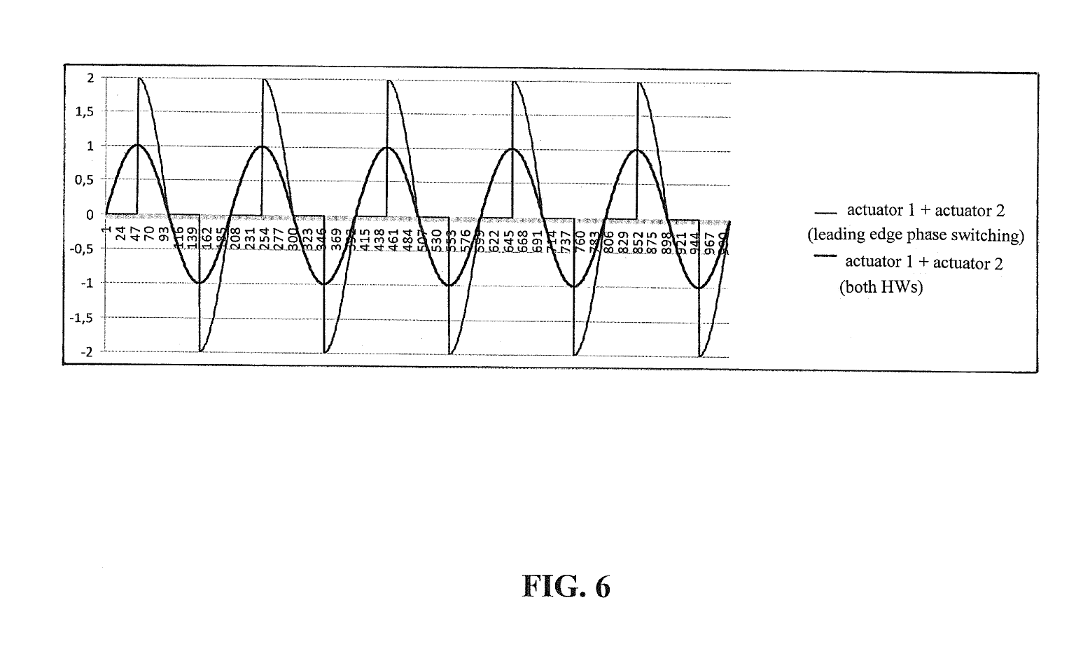

FIG. 6 shows the corresponding results for an overall network load by two consumers with a leading edge phase switching of 49% as compared to the overall network load by two consumers with a leading edge phase switching of 98% with switched-off negative and positive half waves.

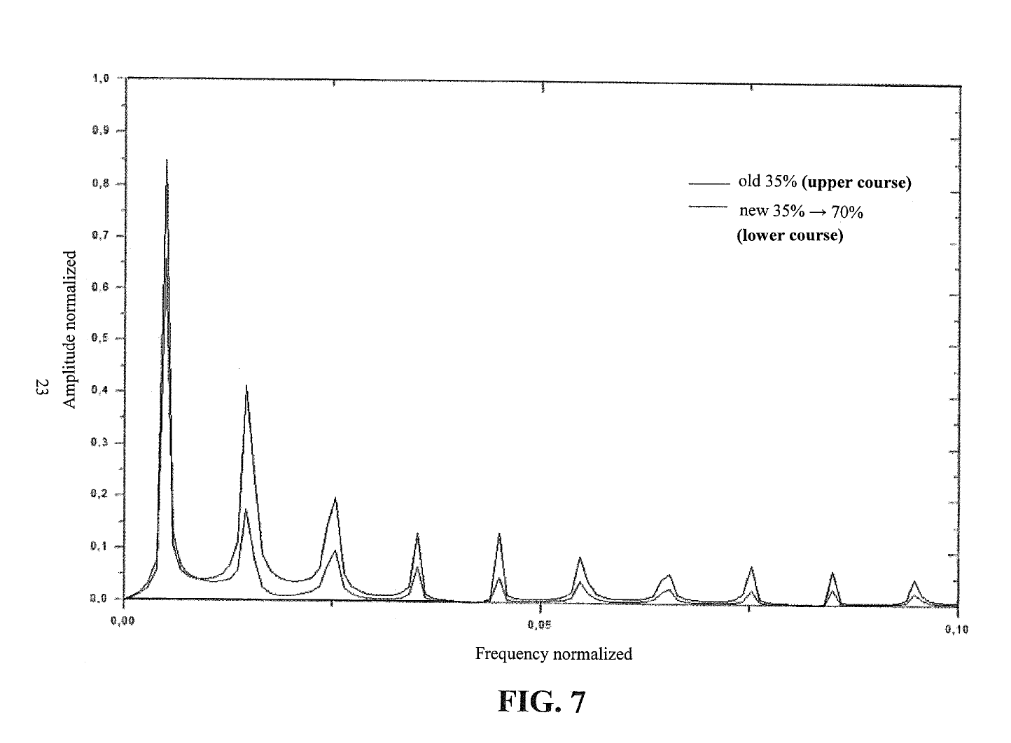

FIG. 7 shows the harmonics by a Fourier transformation. Based on the example of a leading edge phase switching of 35% according to FIG. 2(c) and a leading edge phase switching of 70% with switched-off half waves according to FIG. 3(c) it is evident that the ratio of the amplitudes of the harmonics is in fact smaller in case of switched-off negative and positive half waves and enlarged leading edge phase switching.

It is thus possible to reduce the loads of the supply networks also in case of systems with high load currents that are controlled by leading edge phase switching. The reduction in the harmonics described above can prevent reactive power, so that the use of the above method and/or the corresponding device might lead to enormous possible savings in connection with the realization of a reactive power compensation system and thus in connection with the energy costs.

What is claimed is:

1. A method for operating a first and a second electrical consumer in an AC network, comprising:
an optional first operating mode, in which the positive and negative half waves for each consumer are controlled with a first leading edge phase angle or a first trailing edge phase angle, and
a second operating mode, in which a first part of the positive and negative half waves is controlled for the first consumer and a second part of the positive and the negative half waves for the second consumer, in each case with a second leading edge phase angle or a second trailing edge phase angle, respectively.

2. The method according to claim 1, wherein the first part of the half waves are the positive half waves and the second part of the half waves are the negative half waves.

3. The method according to claim 1, wherein, for a number of q≧2 consumers,
the first part of the positive and negative half waves are the half waves of the (1+q·(N−1)·Z)-th full waves,
the second part of the positive and negative half waves are the half waves of the (Z+1+q·(N−1)·Z)-th full waves, and
a q^{th} part of the positive and negative half waves are the half waves of the
((q−1)·Z+1+q·(N−1)·Z)-th full waves,
wherein N is an integer greater than zero and Z is the number of subsequent full waves for a consumer.

4. The method according to claim 1, wherein the second leading edge phase angle or the second trailing edge phase angle is equal for each consumer.

5. The method according to claim 1, wherein the second leading edge phase angle is smaller than the first leading edge phase angle or the second trailing edge phase angle is larger than the first trailing edge phase angle.

6. The method according to claim 2, further comprising:
synchronizing the consumers such that the controlled positive and negative half waves are not superimposed structurally and/or destructively.

7. The method according to claim 1, further comprising:
switching from the first into the second operating mode if the first leading edge phase angle is at least 90° or if the first trailing edge phase angle is smaller than or equal to 90°.

8. The method according to claim 1, further comprising:
switching from the second into the first operating mode if the second leading edge phase angle is approximately 0° or equal to 0° or if the second trailing edge phase angle is approximately 180° or equal to 180°.

9. A device for operating electrical consumers in an AC network with a first leading edge phase angle of at least 90° or a first trailing edge phase angle smaller than or equal to 90°, comprising
a first and a second leading edge phase-angle controllers or first and second trailing edge phase-angle controllers for a first and a second consumer,
wherein the first leading edge phase-angle controller or the first trailing edge phase-angle controller is suitable for driving a first part of the positive and negative half waves for the first consumer,
wherein the second leading edge phase-angle controller or the first trailing edge phase-angle controller is suitable for driving a second part of the positive and negative half waves for the second consumer, and
wherein the leading edge phase-angle controller or the trailing edge phase-angle controller are suitable for driving the half waves with a second leading edge phase angle or a second trailing edge phase angle.

10. The device according to claim 9, wherein the first part of the half waves are the positive half waves and the second part of the half waves are the negative half waves.

11. The device according to claim 9, wherein, for a number of q≧2 consumers,
the first part of the positive and negative half waves are the half waves of the (1+q·(N−1)·Z)-th full waves,
the second part of the positive and negative half waves are the half waves of the (Z+1+q·(N−1)·Z)-th full waves, and
a q^{th} part of the positive and negative half waves are the half waves of the
((q−1)·Z+1+q·(N−1)·Z)-th full waves,
wherein N is an integer greater than zero and Z is the number of subsequent full waves for a consumer.

12. The device according to claim 9, wherein the first and second leading edge phase-angle controllers or the first and second trailing edge phase-angle controllers are suitable for controlling the half waves for the consumers with the same second leading edge phase angle or the same second trailing edge phase angle.

13. The device according to claim 9, wherein the device is suitable for synchronizing the consumers such that the controlled positive and negative half waves are not superimposed structurally and/or destructively.

14. The device according to claim 9, wherein the device is suitable for operating the electrical consumers in an operating mode in which the positive and negative half waves are controlled both for the first and for the second consumer.

15. The device according to claim 14, wherein the device is suitable for switching between a first operating mode, in which the positive and negative half waves are controlled for both the first and the second consumer, and a second operating mode, in which the negative half waves are switched-off for the first consumer and the positive half waves for the second consumer.
